(19) United States
(12) Patent Application Publication
(10) Pub. No.: US 2025/0136526 A1
(43) Pub. Date: May 1, 2025

(54) PLA COATING OF FERTILISERS

(71) Applicants: thyssenkrupp Uhde GmbH, Dortmund (DE); thyssenkrupp AG, Essen (DE)

(72) Inventor: Yevgeny MAKHYNYA, Muelheim an der Ruhr (DE)

(73) Assignees: thyssenkrupp Uhde GmbH, Dortmund (DE); thyssenkrupp AG, Essen (DE)

(21) Appl. No.: 18/690,674

(22) PCT Filed: Sep. 8, 2022
(86) PCT No.: PCT/EP2022/075033

§ 371 Date: Mar. 8, 2024

(30) Foreign Application Priority Data
Sep. 10, 2021 (BE) BE 2021/5705
Sep. 10, 2021 (DE) 10 2021 210 002.3

(51) Int. Cl. C05G 5/30; C05C 9/00; C05G 5/12

(52) U.S. Cl. CPC C05G 5/37; C05C 9/005; C05G 5/12

(57) ABSTRACT

The present disclosure relates to a particulate fertilizer, where the particulate fertilizer has a coating, where the coating contains polylactic acid compound. The polylactic acid compound has a proportion of 70% to 99% of L-lactic acid monomer units and a proportion of 1% to 30% of D-lactic acid monomer units. This polylactic acid compound comprises at least one first polylactic acid and at least one second polylactic acid. The first polylactic acid has a proportion of 50% to 67% of L-lactic acid monomer units and a proportion of 33% to 50% of D-lactic acid monomer units and the second polylactic acid has a proportion of 95% to 100% of L-lactic acid monomer units and a proportion of 0% to 5% of D-lactic acid monomer units.

The invention relates to a particulate fertilizer with a PLA coating, to the use of a suitable PLA compound, to a solution with PLA for coating, to the use of a corresponding solution and to a method for coating particulate fertilizers.

Patent specification EP 1 890 985 B1 describes a coated fertilizer with a controlled release of active ingredients. Laid-open specification DE 196 03 739 A1 describes mixtures of fertilizer granules. Laid-open specification EP 0 763 510 A1 describes a polymer layer sprayed on by means of fluidized bed granulation. Patent specification U.S. Pat. No. 9,266,787 B2 describes fertilizers having a polymer layer with a specific thickness.

WO 2006 133 893 A2 discloses a coated fertilizer with a controlled release of active ingredients.

JP 07309689 A discloses a fertilizer comprising PLA.

JP 11092304 A discloses a spraying method for a biodegradable polymer.

JP 07033577 A discloses a PLA-coated fertilizer.

DE 10 2017 217 498 A1 discloses a method for producing PLA-coated particulate fertilizers.

However, it has been found that commercially available PLA compounds only have limited solubility in suitable solvents. PLA does have good solubility in many chlorinated solvents, however chlorinated solvents are not suitable for the coatings for ecological reasons. A good-quality coating as well as simple and quick production of the coating is therefore difficult.

It is the object of the invention to find a PLA which enables a good-quality coating in a simpler manner.

This object is achieved by a particulate fertilizer having the features specified in claim 1, by the use of polylactic acid compound having the features specified in claim 7, by a solution having the features specified in claim 10, by the use of the solution having the features specified in claim 14, and by a method for coating having the features specified in claim 15. Advantageous developments will become apparent from the dependent claims and the description that follows.

The particulate fertilizer according to the invention has a coating, where the coating contains polylactic acid compound. It is essential to the invention that the polylactic acid compound has a proportion of 70% to 99%, preferably of 90% to 99%, of L-lactic acid monomer units and 1% to 30%, preferably of 1% to 10%, of D-lactic acid monomer units (i.e. the polylactic acid compound has a proportion of 70% to 99% of L-lactic acid monomer units and a proportion of 1% to 30% of D-lactic acid monomer units, preferably a proportion of 90% to 99% of L-lactic acid monomer units and a proportion of 1% to 10% of D-lactic acid monomer units).

The proportions of the respective lactic acid monomer units are in particular specified as molar proportions, based on the total amount of monomer units in the polylactic acid compound or in the respective polylactic acid (corresponding to “mol %”; on account of the identical molecular weights of the two different lactic acid monomer units, this specification in the present case is identical to the mass fraction in % by weight). With the exception of unavoidable impurities, the molar proportions of the L-lactic acid monomer units and the molar proportions of the D-lactic acid monomer units in particular amount to 100% in each case.

A polylactic acid compound in the context of the invention comprises at least one first polylactic acid and is a mixture (blend) of two different polylactic acids, but may also be a mixture of a greater number of different polylactic acids. Besides this, the polylactic acid compound may comprise dimers or oligomers of lactic acid, preferably at less than 5% by weight; since these also consist of lactic acid monomer units, they may in particular also contribute to the molar proportion of the respective lactic acid monomer units in the polylactic acid compound. In addition, the polylactic acid compound may contain up to 5% by weight of other components, for example dyes for coloring the product. These other components in particular do not contribute to the mass fraction and not to the molar proportion of the respective lactic acid monomer units.

Polylactic acid (polylactide, PLA) is often produced via ring-opening polyaddition of lactide, a cyclic ester composed of two lactic acid monomer units. Since lactic acid has a stereogenic center, there are three possible lactides. The first consists of two L-lactic acid monomer units and is correspondingly called L-lactide. A second consists of two D-lactic acid monomer units and is correspondingly called D-lactide. A third consists of one L-lactic acid monomer unit and one D-lactic acid monomer unit and is referred to as meso-lactide. The lactides are separated before the ring-opening polyaddition, with use being made of pure L-lactide for most applications. The resulting polymer, also called PLLA, has comparatively high crystallinity and a melting point of up to over 175° C. If the proportion of D-lactic acid monomer units in the polylactic acid increases, then from a proportion of about 6% of D-lactic acid monomer units the polymer obtained is amorphous and has a lower melting point, which can be below 130° C.

Pure PLLA has extremely high crystallinity and a high melting point. Crystallinity and melting point decrease as the proportion of D-lactic acid monomer units increases. It has been found that the suitability for the coating of particulate fertilizers is particularly good in the case of an appropriate proportion of D-lactic acid monomer units.

In one embodiment of the invention, the polylactic acid compound has a proportion of 95% to 98% of L-lactic acid monomer units and a proportion of 2% to 5% of D-lactic acid monomer units.

According to the invention, the polylactic acid compound comprises at least one first polylactic acid and at least one second polylactic acid. According to the invention, the first polylactic acid here has a proportion of 50% to 67% of L-lactic acid monomer units and a proportion of 33% to 50% of D-lactic acid monomer units. Due to the random nature of the polymerization, the respective proportions of monomers in the individual polymer molecules are in particular subject to a certain margin of fluctuation and therefore only represent average values.

If meso-lactide is used for the ring-opening polyaddition, then what is ideally obtained is an atactic polymer having 50% L-lactic acid monomer units and 50% D-lactic acid monomer units, since the ring opening is usually effected non-stereoselectively. The polylactic acid obtained is also called m-PLA or PDLLA. For most applications, however, the meso-lactide is not completely purified, and so a usually present excess of the natural L-lactic acid monomer unit results in a ratio of 2:1 to 1:1 for L:D. Even though some properties of PDLLA have proven to be unfavorable for many applications, it has been found specifically for the coating of fertilizers that PDLLA has at least two positive properties. Firstly the solubility in suitable (environmentally friendly) solvents, for example acetone (propanone), is significantly higher, and secondly the biodegradability is also facilitated or accelerated. The first property facilitates the coating, and the second property facilitates the release of the fertilizer on the field and the subsequent rapid, complete and residue-free degradation. It has thus been found that specifically coatings which have at least one first polylactic acid, where the first polylactic acid has a proportion of 50% to 67% of L-lactic acid monomer units and a proportion of 33% to 50% of D-lactic acid monomer units, are surprisingly well suited for the coating of particulate fertilizers. Pure PDLLA is less suitable for a coating since softening already occurs at the customary processing temperatures.

This can then result in instances of adhesion during the coating process. The processability of pure PDLLA is therefore not optimal, even though the solubility would be advantageous for the coating.

According to the invention, the second polylactic acid here has a proportion of 95% to 100% of L-lactic acid monomer units and a proportion of 0% to 5% of D-lactic acid monomer units. The second polylactic acid is thus preferably PLLA and therefore crystalline. Due to the random nature of the polymerization, the respective proportions of monomers in the different polymer molecules are in particular subject to a certain margin of fluctuation and therefore only represent average values.

As already stated, the polylactic acid compound may also comprise more than two polylactic acids, for example a further first polylactic acid, a further second polylactic acid, a third polylactic acid, a fourth polylactic acid and the like. A further first polylactic acid is in particular a polylactic acid having, like the at least one first polylactic acid, a composition from the range of the first polylactic acid, and so this is a polylactic acid also having, like the at least one first polylactic acid, a proportion of 50% to 67% of L-lactic acid monomer units and a proportion of 33% to 50% of D-lactic acid monomer units, but having a composition that deviates from the composition of the at least one first polylactic acid. A further second polylactic acid is in particular a polylactic acid having, like the at least one second polylactic acid, a composition from the range of the second polylactic acid, namely a proportion of 95% to 100% of L-lactic acid monomer units and a proportion of 0% to 5% of D-lactic acid monomer units, but having a composition that deviates from the composition of the at least one second polylactic acid. The third polylactic acid, the fourth polylactic acid and each of any further polylactic acids is in particular a polylactic acid having neither a composition from the range of the first polylactic acid nor a composition from the range of the second polylactic acid. By way of example, the third polylactic acid, the fourth polylactic acid and any further polylactic acids each have a mass of at most 10% of the total mass of the polylactic acid compound (corresponding to 10% by weight). In particular, the mass fraction of the first polylactic acid and the mass fraction of the second polylactic acid and also the mass fractions of any further polylactic acids-apart from unavoidable impurities—each add up to 100% of the total mass of the polylactic acid compound (corresponding to 100% by weight). The respective polylactic acids here may also be copolymers of polylactic acids.

In a further embodiment of the invention, the coating has a proportion of the first polylactic acid of 0.1% by weight to 50% by weight and a proportion of the second polylactic acid of 50% by weight to 99.9% by weight.

In a further embodiment of the invention, the coating has a proportion of the first polylactic acid of 5% by weight to 50% by weight, preferably 7.5% by weight to 25% by weight, particularly preferably of 10% by weight to 20% by weight, and a proportion of the second polylactic acid of 50% by weight to 95% by weight, preferably 75% by weight to 92.5% by weight, particularly preferably of 80% by weight to 90% by weight. This especially also includes a coating having a proportion of the first polylactic acid of 5% by weight to 50% by weight and a proportion of the second polylactic acid of 50% by weight to 95% by weight, preferably a coating having a proportion of the first polylactic acid of 7.5% by weight to 25% by weight and a proportion of the second polylactic acid of 75% by weight to 92.5% by weight, and particularly preferably a coating having a proportion of the first polylactic acid of 10% by weight to 20% by weight and a proportion of the second polylactic acid of 80% by weight to 90% by weight.

In this embodiment, the largest proportion of the polylactic acid compound is thus a crystalline PLLA and only a certain admixture of a PDLLA. This makes it possible to obtain a coating which has a comparatively similar property in terms of mechanical strength and release dynamics to a pure PLLA coating, but enables a greater solubility and therefore simpler production on account of the proportion of PDLLA.

In a further embodiment of the invention, the particulate fertilizer has a core, where the core consists to an extent of at least 80% by weight of urea. Urea is currently the most important nitrogen fertilizer.

In a further embodiment of the invention, the particulate fertilizer has a core, where the core consists to an extent of at least 80% by weight of calcium ammonium nitrate.

In a further embodiment of the invention, the particulate fertilizer has a core, where the core consists to an extent of at least 80% by weight of PK, a complex mixed fertilizer consisting of two main nutrients for plants (phosphorus in the form of phosphates, generally mono-and diammonium phosphate, and potassium in the form of potassium salts).

In a further embodiment of the invention, the particulate fertilizer has a core, where the core consists to an extent of at least 80% by weight of NPK, a complex mixed fertilizer consisting of three main nutrients for plants (nitrogen in the form of nitrates and/or urea, phosphorus in the form of phosphates, generally mono- and diammonium phosphate, and potassium in the form of potassium salts).

In a further aspect, the invention relates to the use of a polylactic acid compound for coating fertilizers. According to the invention, the polylactic acid compound has a proportion of 70% to 99% of L-lactic acid monomer units, preferably a proportion of 90% to 99% of L-lactic acid monomer units, and a proportion of 1% to 30% of D-lactic acid monomer units, preferably a proportion of 1% to 10% of D-lactic acid monomer units.

What has been stated for the coating of the particulate fertilizer applies analogously to the use. This also applies to the further embodiments.

According to the invention, the polylactic acid compound comprises at least one first polylactic acid, where the first polylactic acid has a proportion of 50% to 67% of L-lactic acid monomer units and a proportion of 33% to 50% of D-lactic acid monomer units. In addition, the polylactic acid compound further also comprises at least one second polylactic acid, where the second polylactic acid has a proportion of 95% to 100% of L-lactic acid monomer units and a proportion of 0% to 5% of D-lactic acid monomer units.

In a further embodiment of the invention, the polylactic acid compound has a proportion of the first polylactic acid of 5% by weight to 50% by weight, preferably a proportion of 7.5% by weight to 25% by weight, particularly preferably a proportion of 10% by weight to 20% by weight, and a proportion of the second polylactic acid of 50% by weight to 95% by weight, preferably a proportion of 75% by weight to 92.5% by weight, particularly preferably a proportion of 80% by weight to 90% by weight. This especially also includes a polylactic acid compound having a proportion of the first polylactic acid of 5% by weight to 50% by weight and a proportion of the second polylactic acid of 50% by weight to 95% by weight, preferably a polylactic acid compound having a proportion of the first polylactic acid of 7.5% by weight to 25% by weight and a proportion of the second polylactic acid of 75% by weight to 92.5% by weight, particularly preferably a polylactic acid compound having a proportion of the first polylactic acid of 10% by weight to 20% by weight and a proportion of the second polylactic acid of 80% by weight to 90% by weight.

In a further aspect, the invention relates to a solution for coating particulate fertilizers, where the solution comprises, as solvent, acetone or a solvent mixture having at least 90% by weight of acetone.

According to the invention, 1% by weight to 25% by weight, preferably 4% by weight to 17% by weight, of a polylactic acid compound is dissolved in the solvent. The polylactic acid compound has a proportion of 70% to 99% of L-lactic acid monomer units, preferably a proportion of 90% to 99% of L-lactic acid monomer units, and a proportion of 1% to 30% of D-lactic acid monomer units, preferably a proportion of 1% to 10% of D-lactic acid monomer units.

What has been stated for the coating of the particulate fertilizer applies analogously to the solution. This also applies to the further embodiments.

In a further embodiment of the invention, the polylactic acid compound comprises at least one first polylactic acid, where the first polylactic acid has a proportion of 50% to 67% of L-lactic acid monomer units and a proportion of 33% to 50% of D-lactic acid monomer units.

In a further embodiment of the invention, the polylactic acid compound comprises at least one second polylactic acid, where the second polylactic acid has a proportion of 95% to 100% of L-lactic acid monomer units and a proportion of 0% to 5% of D-lactic acid monomer units.

According to the invention, the polylactic acid compound dissolved in the solution comprises at least one first polylactic acid, where the first polylactic acid has a proportion of 50% to 67% of L-lactic acid monomer units and a proportion of 33% to 50% of D-lactic acid monomer units. In addition, the polylactic acid compound comprises at least one second polylactic acid, where the second polylactic acid has a proportion of 95% to 100% of L-lactic acid monomer units and a proportion of 0% to 5% of D-lactic acid monomer units.

In a further embodiment of the invention, the polylactic acid compound has a proportion of the first polylactic acid of 5% by weight to 50% by weight, preferably a proportion of 7.5% by weight to 25% by weight, particularly preferably a proportion of 10% by weight to 20% by weight, and a proportion of the second polylactic acid of 50% by weight to 95% by weight, preferably a proportion of 75% by weight to 92.5% by weight, particularly preferably a proportion of 80% by weight to 90% by weight. This especially also includes a polylactic acid compound having a proportion of the first polylactic acid of 5% by weight to 50% by weight and a proportion of the second polylactic acid of 50% by weight to 95% by weight, preferably a polylactic acid compound having a proportion of the first polylactic acid of 7.5% by weight to 25% by weight and a proportion of the second polylactic acid of 75% by weight to 92.5% by weight, particularly preferably a polylactic acid compound having a proportion of the first polylactic acid of 10% by weight to 20% by weight and a proportion of the second polylactic acid of 80% by weight to 90% by weight.

In a further embodiment of the invention, 12% by weight to 18% by weight of a polylactic acid compound is dissolved in the solvent. This significantly exceeds the solubility of crystalline PLLA under standard conditions and is achieved by the addition of PDLLA.

In a further aspect, the invention relates to the use of a solution according to the invention for coating particulate fertilizers.

In a further aspect, the invention relates to a method for coating a particulate fertilizer, where an uncoated particulate fertilizer is coated with a solution according to the invention in a coater. Preferably, the method is carried out in a fluidized bed coater or a drum coater. A corresponding method is known to those skilled in the art for example and in particular from DE 10 2017 217 498 A1. The method according to the invention can easily be supplemented by those skilled in the art in accordance with the disclosure of method steps in DE 10 2017 217 498 A1.

1-16. (canceled)

17. A particulate fertilizer, where the particulate fertilizer has a coating, where the coating contains polylactic acid compound having a proportion of 70% to 99% of L-lactic acid monomer units and a proportion of 1% to 30% of D-lactic acid monomer units, wherein the polylactic acid compound comprises at least one first polylactic acid and at least one second polylactic acid;
wherein the first polylactic acid has a proportion of 50% to 67% of L-lactic acid monomer units and a proportion of 33% to 50% of D-lactic acid monomer units; and
wherein the second polylactic acid has a proportion of 95% to 100% of L-lactic acid monomer units and a proportion of 0% to 5% of D-lactic acid monomer units.

18. The particulate fertilizer as claimed in claim 17, wherein the polylactic acid compound has a proportion of 95% to 98% of L-lactic acid monomer units and a proportion of 2% to 5% of D-lactic acid monomer units.

19. The particulate fertilizer as claimed in claim 18 wherein the polylactic acid compound has a proportion of the first polylactic acid of 5% by weight to 50% by weight and a proportion of the second polylactic acid of 50% by weight to 95% by weight.

20. The particulate fertilizer as claimed in claim 19 wherein the polylactic acid compound has a proportion of the first polylactic acid of 7.5% by weight to 25% by weight and a proportion of the second polylactic acid of 75% by weight to 92.5% by weight.

21. The particulate fertilizer as claimed in claim 20 wherein the polylactic acid compound has a proportion of the first polylactic acid of 10% by weight to 20% by weight and a proportion of the second polylactic acid of 80% by weight to 90% by weight.

22. The particulate fertilizer as claimed in claim 21 the particulate fertilizer has a core, where the core consists to an extent of at least 80% by weight of urea.

23. A polylactic acid compound for coating fertilizers, where the polylactic acid compound has a proportion of 70% to 99% of L-lactic acid monomer units and a proportion of 1% to 30% of D-lactic acid monomer units, wherein the polylactic acid compound comprises at least one first polylactic acid and at least one second polylactic acid;
wherein the first polylactic acid has a proportion of 50% to 67% of L-lactic acid monomer units and a proportion of 33% to 50% of D-lactic acid monomer units; and
wherein the second polylactic acid has a proportion of 95% to 100% of L-lactic acid monomer units and a proportion of 0% to 5% of D-lactic acid monomer units.

24. The polylactic acid compound as claimed in claim 23, wherein the polylactic acid compound has a proportion of the first polylactic acid of 10% by weight to 20% by weight, and a proportion of the second polylactic acid of 80% by weight to 90% by weight.

25. The polylactic acid compound as claimed in claim 24, wherein the polylactic acid compound has a proportion of the first polylactic acid of 10% by weight to 20% by weight and a proportion of the second polylactic acid of 80% by weight to 90% by weight.

26. A method for coating an uncoated particulate fertilizers with a solution, where the solution comprises, at least one of as solvent, acetone and a solvent mixture having at least 90% by weight of acetone;
dissolving 1% by weight to 25% by weight of a polylactic acid compound in the solvent, where the polylactic acid compound has a proportion of 70% to 99% of L-lactic acid monomer units and a proportion of 1% to 30% of D-lactic acid monomer units, wherein the polylactic acid compound comprises at least one first polylactic acid and at least one second polylactic acid; wherein the first polylactic acid has a proportion of 50% to 67% of L-lactic acid monomer units and a proportion of 33% to 50% of D-lactic acid monomer units; and wherein the second polylactic acid has a proportion of 95% to 100% of L-lactic acid monomer units and a proportion of 0% to 5% of D-lactic acid monomer units; and
coating the uncoated particulate fertilizer with the solution.

27. The method as claimed in claim 26, wherein the polylactic acid compound has a proportion of the first polylactic acid of 7.5% by weight to 25% by weight and a proportion of the second polylactic acid of 75% by weight to 92.5% by weight.

28. The method as claimed in claim 27, wherein the polylactic acid compound has a proportion of the first polylactic acid of 10% by weight to 20% by weight, and a proportion of the second polylactic acid of 80% by weight to 90% by weight.

29. The method as claimed in claim 28 wherein 12% by weight to 18% by weight of a polylactic acid compound is dissolved in the solvent.

30. The method of claim 27, where the uncoated particulate fertilizer is coated in a coater.

31. The method as claimed in claim 30 wherein the particulate fertilizer is coated in one of a fluidized bed coater and a drum coater.
